(19) United States
(12) Patent Application Publication
(10) Pub. No.: US 2011/0285764 A1
(43) Pub. Date: Nov. 24, 2011

(54) VIDEO DISPLAY DEVICE

(75) Inventors: Katsunobu KIMURA, Tokyo (JP); Nobuo Masuoka, Chigasaki (JP)

(73) Assignee: Hitachi Consumer Electronics Co., Ltd.

(21) Appl. No.: 13/092,386

(22) Filed: Apr. 22, 2011

(30) Foreign Application Priority Data
May 20, 2010 (JP) 2010-116443

(51) Int. Cl. G09G 3/36; G09G 5/02

(52) U.S. Cl. 345/697; 345/102

(57) ABSTRACT

A video display device is provided with a backlight for projecting light onto a display panel composed of plural backlight blocks two-dimensionally arranged, for controlling the intensity of light for each of the backlight blocks by local dimming control. In the video display device, video, such as letterbox video, having a black blank portion and a video portion is displayed so as to nearly align a boundary between the video portion and the blank portion with a boundary between the backlight blocks. Also, reduced display is performed using only a portion of the backlight blocks in both horizontal and vertical directions while nearly aligning the boundary between the video portion and the blank portion with the boundary between the backlight blocks.

### INCORPORATION BY REFERENCE

This application relates to and claims priority from Japanese Patent Application No. 2010-116443 filed on May 20, 2010, the entire disclosure of which is incorporated herein by reference.

### BACKGROUND OF THE INVENTION

1. Field of the Invention

The present invention relates to a video display device, and more particularly, to a low-power-consumption video display device.

2. Description of the Related Art

In video display devices such as liquid crystal display devices, there have been developed technologies for reducing power consumption in response to the current trend toward energy conservation.

Japanese Patent Application Laid-Open No. 2003-156728 discloses a technique for reducing the power consumption of a backlight unit when the output voltage of a battery is reduced in a liquid crystal display device. Also, Japanese Patent Application Laid-Open No. 2001-21863 discloses a technique for reducing the power consumption of a backlight light source in an image display device.

In addition, as a backlight for use in liquid crystal display devices, there has been known a so-called tandem backlight, as disclosed in Japanese Patent Application Laid-Open No. 2007-293339, in which light guide plates made, for example, of transparent resin, for converting a point light source such as an LED to a surface light source for illumination are two-dimensionally arranged. In such tandem backlight, there can be adopted area control (referred to as “local dimming control”) in which, according to video signals, for example, the light source of the light guide plate located in a position corresponding to dim video is dimmed or turned off, and the light source of the light guide plate located in a position corresponding to bright video is brightened. By this local dimming, it is possible to prevent whitening phenomenon of black portions to enhance contrast, and reduce power consumption.

### SUMMARY OF THE INVENTION

In the local dimming control used in the tandem backlight as described above, basically, the intensity of the light exiting from each of the light guide plates is controlled with reference to a maximum value of the video corresponding to the light guide plate. For example, even when the video corresponding to a light guide plate has a high proportion of the black area, if the video includes a partial white (bright) portion, the light source corresponding to the light guide plate is controlled to be brightened according to the brightness of the bright portion (when the white portion has a maximum brightness, the light source is also set to a maximum value) so as to allow the bright portion to be displayed at a desired brightness. With respect to video with a black band at the top and bottom thereof, called letterbox video, therefore, the light source corresponding to the light guide plate located in a position straddling both a video content display portion and a portion of the black band is turned on according to the brightness of the video content. For this reason, in the local dimming control used in the tandem backlight, there are cases where the low power consumption effect cannot be sufficiently exerted.

Accordingly, in view of the problem described above, an object of the present invention is to provide a low-power-consumption video display device.

In order to address the above-described problem, according to one aspect of the present invention, a video display device having a liquid crystal panel, and a backlight with plural backlight blocks horizontally and vertically arranged for projecting light onto the liquid crystal panel, capable of controlling the intensity of light for each of the backlight blocks, includes: a receiving portion for receiving a video signal to be displayed on the liquid crystal panel; a scaler for performing processing for changing the size and/or position in a horizontal and/or vertical direction of the video signal received by the receiving portion; a backlight controller for controlling the intensity of light for each of the backlight blocks based on the video signal; and a display controller for controlling operation of the scaler. The display controller controls the scaler to change the size and/or position in the horizontal and/or vertical direction of the video signal so as to nearly align a boundary between a video portion and a blank portion included in the video signal with a boundary between the backlight blocks. The backlight controller performs control to reduce the intensity of light of the backlight blocks in a position corresponding to the blank portion.

According to the present invention, it is possible to provide a low-power-consumption video display device.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of a video display device according to an embodiment of the present invention;

FIG. 2 shows a first example of a display screen;

FIG. 3A shows a second example of the display screen;

FIG. 3B shows an enlarged display screen of the second example according to the embodiment of the present invention;

FIG. 3C shows a reduced display screen of the second example according to the embodiment of the present invention;

FIG. 4A shows a third example of the display screen;

FIG. 4B shows a shifted display screen of the third example according to the embodiment of the present invention;

FIG. 5A shows a fourth example of the display screen;

FIG. 5B shows a display screen, with the position of a caption in the fourth example shifted, according to the embodiment of the present invention;

FIG. 5C shows a display screen, with the position of a caption in the fourth example shifted, according to the embodiment of the present invention;

FIG. 6A shows a fifth example of the display screen;

FIG. 6B shows an enlarged display screen of the fifth example according to the embodiment of the present invention;

FIG. 6C shows a shifted display screen of the fifth example according to the embodiment of the present invention;

FIG. 6D shows a shifted display screen of the fifth example according to the embodiment of the present invention;

FIG. 7A shows a sixth example of the display screen;

FIG. 7B shows a reduced display screen of the sixth example according to the embodiment of the present invention;

FIG. 7C shows a reduced display screen of the sixth example according to the embodiment of the present invention;

FIG. 8A shows a seventh example of the display screen;

FIG. 8B shows a reduced display screen of the seventh example according to the embodiment of the present invention;

FIG. 8C shows a reduced display screen of the seventh example according to the embodiment of the present invention;

FIG. 9 is a front view of a remote control according to the embodiment of the present invention;

FIG. 10A shows a display screen, with a wide mode menu displayed, according to the embodiment of the present invention;

FIG. 10B shows a display screen, with a wide mode menu displayed, according to the embodiment of the present invention;

FIG. 11 shows one construction of a backlight block according to the embodiment of the present invention; and

FIG. 12 shows one example of a direct backlight to which the embodiment of the present invention is applied.

### DETAILED DESCRIPTION OF THE EMBODIMENT

Hereinafter, an embodiment of the present invention will be described with reference to the accompanying drawings.

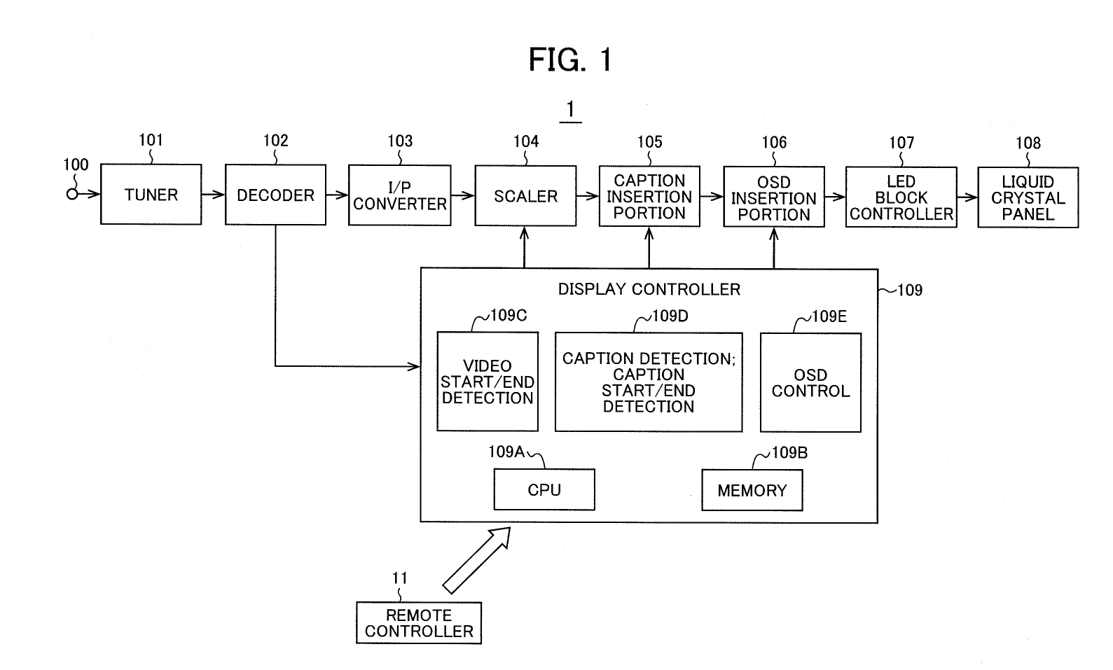

FIG. 1 is a block diagram of a video display device 1 according to an embodiment of the present invention. Firstly, the operation of the whole video display device will be described by using FIG. 1.

To a tuner (also referred to as a receiving portion) 101 through an input terminal 100, there are supplied radio signals of a television broadcast received by a receiving antenna (not shown) external or internal to the video display device 1. The tuner 101 extracts the radio signal of a channel designated by a user from the supplied radio signals, and converts the frequency of the radio signal into a predetermined band, and then demodulates the signal subjected to modulation for transmission on the broadcasting station side to supply the demodulated signal, as a baseband band signal, to a decoder (also referred to as a received signal processor) 102.

Thereafter, for example, in the case of the current digital broadcasting, the decoder 102 selects a broadcast in a predetermined time slot designated by the user from the baseband band signal (this process is referred to as demultiplexing), and decodes the radio signal subjected to data compression for transmission on the broadcasting station side into a video signal, and then supplies the video signal to an I/P converter 103.

The I/P converter 103 converts the supplied video signal from an interlaced scanning signal to a progressive scanning signal.

A following scaler 104, caption insertion portion 105, and OSD (On Screen Display) insertion portion 106 are all controlled by a display controller 109 including a CPU (Central Processing Unit) 109A. Firstly, the scaler 104, for example, reduces (or may enlarge, and reduction and enlargement are also referred to collectively as scaling) the video signal supplied from the I/P converter 103 according to instructions from the display controller 109 to supply the video signal to the caption insertion portion 105. It should be noted that a detailed description of the operation of the scaler 104 will be given later.

The caption insertion portion 105 inserts a caption supplied from the broadcasting station along with the video signal into the supplied video signal, in a position based on an instruction from the display controller 109, and supplies the video signal to the OSD insertion portion 106.

The OSD insertion portion 106 inserts an OSD to be displayed together with the video signal or to be displayed as a substitute for the video signal, into the supplied video signal, in a position based on an instruction from the display controller 109, and supplies the video signal to an LED block controller 107. It should be noted that detailed descriptions of the operations of the caption insertion portion 105 and the OSD insertion portion 106 will be also given later.

The display controller 109 is supplied with a portion or the whole of the signal obtained by decoding with the decoder 102 so as to control the scaler 104, the caption insertion portion 105, and the OSD insertion portion 106. This signal may be the signal subjected to progressive conversion by the I/P converter 103 rather than the signal obtained by the decoder 102. Alternatively, a control signal for the video signal extracted by the decoder 102 may be supplied to the display controller 109.

The display controller 109 may be configured with a single microprocessor (CPU), and the single microprocessor may contain all the functions of the display controller 109. Further, the above single microprocessor may contain the decoder 102, the I/P converter 103, the scaler 104, the caption insertion portion 105, and the OSD insertion portion 106.

The LED block controller 107 controls the opening and closing of a shutter included in a liquid crystal panel 108 according to the supplied video signal. Also, in the case of the local dimming control, the LED block controller 107 displays video on a display of the liquid crystal panel 108 while controlling the brightness of the light source for each light guide plate of the liquid crystal panel 108.

Next, the display control over the scaler 104, the caption insertion portion 105, and the OSD insertion portion 106 performed by the display controller 109, which is one of the features of this embodiment, will be described. It should be noted that, of various kinds of display control on the liquid crystal panel 108, the above-described local dimming control and the opening and closing control of the liquid crystal shutter are performed by the LED block controller 107, and many other kinds of display control are performed by the display controller 109.

Firstly, a video start/end detector 109C of the display controller 109 detects a start position and an end position (which may be on a display screen or on a time axis) in a horizontal direction (H) and in a vertical direction (V) with respect to a video signal for one field (or frame) based on the video signals supplied from the decoder 102 or the I/P converter 103 to supply the position data to the scaler 104. When the appropriate position data is added, as data for control, in a time-sharing manner in a slot different from the video signal, processing can be executed by detecting the data for control.

In the scaler 104, the video signal is, for example, reduced in the vertical or horizontal direction based on the supplied position data and the display format (including a display range and an aspect ratio) on the liquid crystal panel 108 instructed by the CPU 109A and then supplied to the caption insertion portion 105. The video signal formats include traditional analog broadcast formats having an aspect ratio of 3:4, various digital broadcast formats having an aspect ratio of 9:16, and further horizontally-elongated formats (for example, having an aspect ratio of 1:2.35) converted from a movie. The scaler 104 has the function of converting the aspect ratio of the video signal so that video signals of any format are displayed with almost no distortion in aspect ratio on the liquid crystal panel 108 having a predetermined aspect ratio. The memory for temporarily storing video signals for this processing may be a memory 109B included in the display controller 109, or alternatively, a memory (not shown) included in the scaler 104 itself.

It should be noted that the scaler 104 may have the function of enlarging the video signal as well as reducing the video signal for performing the aspect ratio conversion described above. Also, as for display on the liquid crystal panel 108, the arrangement may be such that the scaler 104 converts the video signal so as to perform display with almost no distortion in aspect ratio in the vicinity of the center that is mostly observed by a viewer, and converts the aspect ratio at both ends of the video signal so as to perform display, for example, in a slightly horizontally-elongated manner, thereby effectively using the display screen in the horizontal direction. It should be also noted that, hereinafter, the video signal reducing and enlarging conversions with the scaler 104 may be referred to as scaling.

Next, a caption detector 109D detects caption data added in the time-sharing manner to the video signal supplied from the decoder 102, and the position data about a start position and an end position in the horizontal direction (H) and in the vertical direction (V) for inserting the caption data in the video signal to be displayed, and supplies both to the caption insertion portion 105.

The caption insertion portion 105 inserts the supplied caption data into the video signal based on the supplied position data. Alternatively, the caption insertion may be performed based on the position data instructed by the CPU 109A of the display controller 109 instead of the above position data. The position data instructed by the CPU 109A is produced by the caption detector 109D, for example based on the caption position instructed by the user with a remote control (remote controller) 11.

With respect to the caption inserted by the caption insertion portion 105, preferably, its insertion position and aspect ratio is prevented from being changed due to the influence of scaling with the scaler 104. Therefore, the caption insertion portion 105 is disposed at the subsequent stage of the scaler 104. Obviously, the caption may be subjected to scaling according to the video scaling. In this case, it is only necessary to dispose the caption insertion portion 105 at the previous stage of the scaler 104.

An OSD controller 109E then separates EPG (Electronic Program Guide) data added in the time-sharing manner to the video signal supplied from the decoder 102, and produces an EPG display signal for indicating a broadcast program schedule to supply the EPG display signal to the OSD insertion portion 106.

The OSD insertion portion 106 supplies, in response to a user's instruction from the remote control 11, the EPG display signal supplied from the OSD controller 109E in place of the on-air video signal to the LED block controller 107. Alternatively, the on-air video signal may be incorporated into an EPG display screen. Also, when the user requests a volume display with the remote control 11, the OSD insertion portion 106 incorporates the volume display based on a predetermined display format into the on-air video signal in response to the instruction from the OSD controller 109E.

The OSD image inserted by the OSD insertion portion 106 is independent of the format of the video signal of the received broadcast, and therefore the OSD image format can be independently determined by the video display device 1. Therefore, the OSD insertion portion 106 is disposed at the subsequent stage of the scaler 104 so as to prevent the OSD insertion portion 106 from being influenced by scaling with the scaler 104. It should be noted that the caption insertion portion 105 and the OSD insertion portion 106 may be provided in reverse order.

In addition, the predetermined formats prepared for the EPG and volume display of the OSD inserted by the OSD insertion portion 106 may be stored in the memory 109B, or alternatively, in a memory included in the OSD insertion portion 106 itself.

Next, the display control performed by the display controller 109 will be described with reference to the illustration of the display screen displayed on the liquid crystal panel 108.

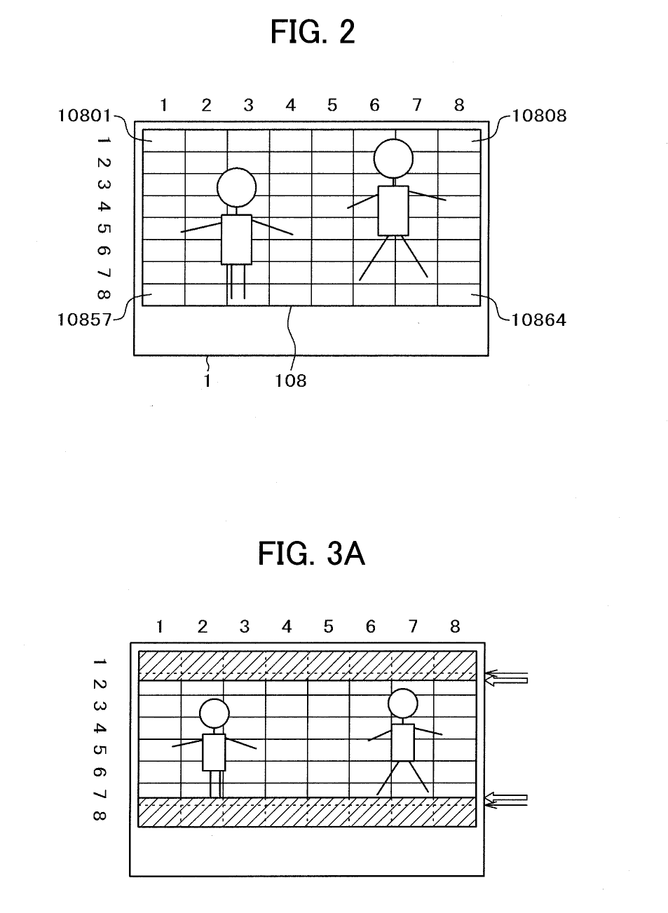

FIG. 2 shows a first example of the display screen. In this figure, video is displayed all over the liquid crystal panel 108 of the video display device 1. This applies to the case, for example, where a video display device with a display having an aspect ratio of 9:16 receives HD (high definition) television.

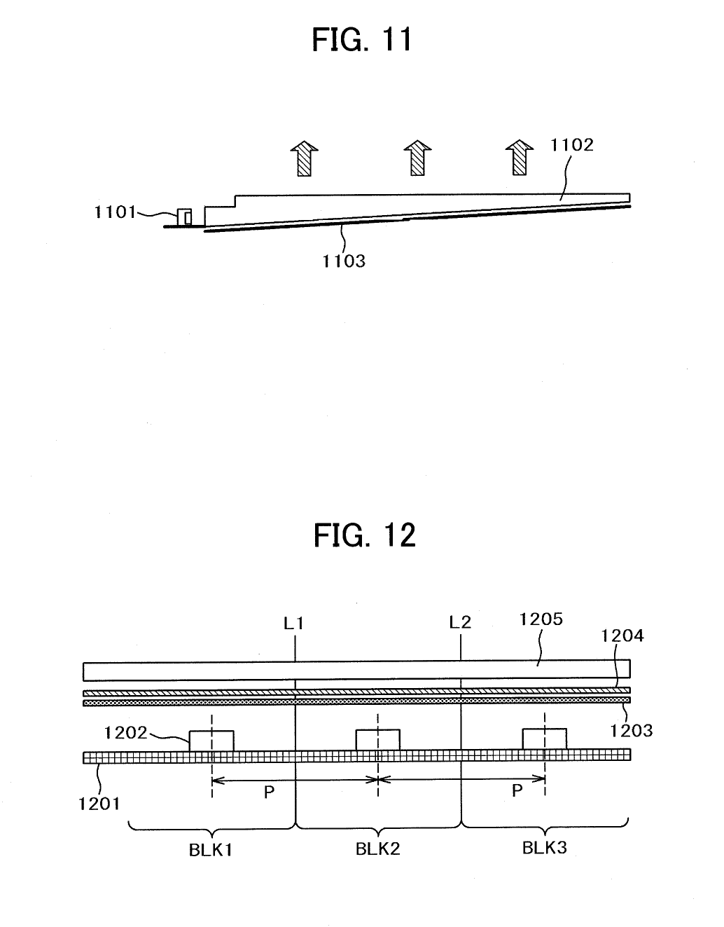

In this embodiment, as a backlight for liquid crystal display devices, there is used a tandem backlight, for example, as disclosed in Japanese Patent Application Laid-Open No. 2007-293339, in which the plural light guide plates for converting a light source such as an LED to a surface light source are two-dimensionally arranged. In other words, the backlight according to this embodiment is composed of plural combinations of the LED and the light guide plate. Hereinafter, a single combination of the LED and the light guide plate will be referred to as a “backlight block”. That is to say, plural backlight blocks each including the LED and the light guide plate are horizontally and vertically arranged to make up a backlight. FIG. 11 shows one construction of the backlight block.

As shown in FIG. 11, each of the backlight blocks includes an LED 1101 serving as a light source, a light guide plate 1102, and a reflector 1103. The light guide plate 1102 is, as shown in FIG. 2, in a rectangular shape as viewed from above (from the side opposite to a direction of light emitted from the backlight, that is, from the direction from which the screen is observed). Also, the longitudinal section of the irradiated surface of the backlight is, as shown in FIG. 11, in a wedge shape that becomes gradually thinner from a light incident end toward a leading end opposed to the light incident end. Thus, from the light entering end to the leading end, the distribution of the brightness of the exit light is equalized.

In FIG. 11, the LED 1101 is a side-view LED that allows, for example, white light to exit, with the light exit direction parallel to an electrode plane, and disposed toward the light incident end of the light guide plate 1102. The light from the LED 1101 enters the end (edge portion) increased in thickness of the light guide plate 1102, and is multiply-reflected in the light guide plate 1102 to exit through an upper surface of the light guide plate 1102 toward the liquid crystal panel (in the direction of the arrow in the figure). Furthermore, the light passing out of the light guide plate 1102 through a lower surface of the light guide plate 1102 is reflected by the reflector 1103 disposed below the lower surface of the light guide plate 1102, and returned to the light guide plate 1102 to exit through the upper surface (light exit surface) of the light guide plate 1102. Thus, the point light source such as an LED is converted to the surface light source. In this embodiment, the single light guide plate 1102 is provided with three LEDs (not shown) and the light from the three LEDs enters the light guide plate 1102.

It should be noted that, in this embodiment, the side-view LED allowing light to exit in the direction parallel to the electrode plane is used as the LED 1101, however, a top-view LED allowing light to exit in the direction perpendicular to the electrode plane may be used. Alternatively, there may be used a combination of three respective LEDs that allow red, blue, and green light instead of white light to emit.

In FIG. 2, plural horizontally-elongated rectangles, shown in the display 108 illustrate the backlight blocks arranged on the back of the display (liquid crystal panel) 108. In other words, in this embodiment, the surface (that is, the light exit surface of the light guide plate) on the light exit side of each of the backlight blocks is formed in a horizontally-elongated rectangular shape. However, the present invention is not limited thereto, but also, for example, a vertically-elongated rectangular shape or a square shape can be applied. In this embodiment, the backlight has eight rows and eight columns, for a total of 64 backlight blocks 10801 to 10864, of which the four backlight blocks located at four corners of the screen are designated by reference signs 10801 to 10864. Obviously, the number of the backlight blocks is illustrative only, and any number of backlight blocks may be provided. For example, the backlight may have eight rows and sixteen columns, for a total of 128 backlight blocks. The light intensity (brightness) of the LEDs as light sources for supplying light to the backlight blocks is controlled for each of the backlight blocks. For example, the LED block controller 107 performs the above-described local dimming control to turn off the LEDs of the backlight block corresponding to an entirely-black (dark) video signal (also referred to as a blank portion), thereby allowing reduction in power consumption. On the other hand, when the image on the display panel corresponding to a backlight block partially includes a bright portion, the light intensity of the LEDs of the backlight block is controlled so as to emit light according to the brightness of the bright portion, as described above. It should be noted that, in the case of an entirely-black (dark) video signal, the backlight block corresponding to the black portion is turned off, however, alternatively, the light having a predetermined brightness (for example, about 10 percent of the maximum brightness) may be emitted.

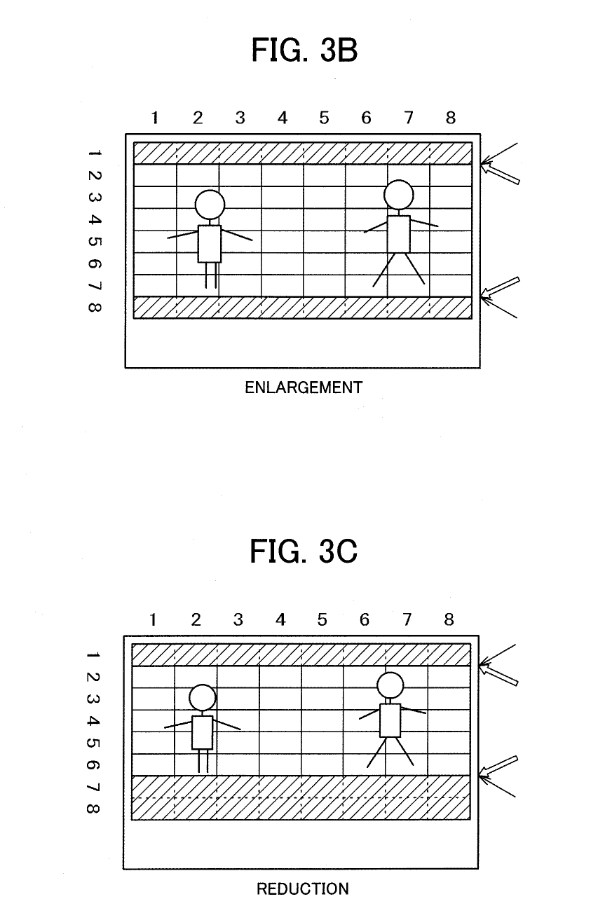

FIG. 3A shows a second example of the display screen. In this figure, there is shown the display in the case where the display 108 is supplied with a letterbox video signal. When a display having an aspect ratio of 9:16 is supplied with a video signal having an aspect ratio of 1:2.35 as used for a movie, in the related art, the video, as for example shown in FIG. 3A is provided. The hatched portion in the figure indicates a black blank portion that is typical of the letterbox video. More specifically, the video corresponding to the backlight blocks (backlight blocks at a top end and a bottom end) in the first and eighth rows is entirely black, and therefore in the same manner as the above, the backlights are turned off, thereby allowing reduction in power consumption.

On the other hand, the video corresponding to each backlight block in the second and seventh rows is bright except for a black portion at an upper end or a lower end of the backlight block. When the boundary between the backlight blocks is located at the level indicated by the thin arrow, the boundary between the letterbox image and the blank portion is located at the level indicated by the bold arrow. Therefore, as for each of the backlight blocks in these rows, it is necessary to turn on the light source of the backlight block although video is not displayed over the entire surface of the backlight block. That is to say, with respect to these backlight blocks, there is a problem that the reduction in power consumption by turning off the light source cannot be performed. In order to address this problem, this embodiment provides the display shown in FIGS. 3B and 3C.

FIG. 3B shows an enlarged display screen of the second example according to the embodiment of the present invention, and FIG. 3C shows a reduced display screen of the second example according to the embodiment of the present invention.

In FIG. 3B, the scaler 104 enlarges the supplied video signal in the vertical direction so as to nearly align the boundary between the letterbox image and the blank portion as indicated by the bold arrow with the boundary between the backlight blocks as indicated by the thin arrow. On the other hand, in FIG. 3C, the scaler 104 reduces the supplied video signal in the vertical direction so as to nearly align the boundary between the letterbox image and the blank portion as indicated by the bold arrow with the boundary between the backlight blocks as indicated by the thin arrow. It should be noted that, in FIG. 3C, the video signal is reduced in the vertical direction and then shifted so that as for the backlight blocks in the second row, the image is displayed over the entire surface thereof, on the other hand, a display area (portion) of the liquid crystal panel corresponding to the backlight blocks in the seventh row is supplied with an entirely-black video signal.

In FIG. 3B, as compared to FIG. 3A, the power consumption of the backlight is similar to that in FIG. 3A, however, the entire surface of the lighted backlight blocks can be more effectively used. Further, in FIG. 3A, whitening phenomenon occurs in black blank portions displayed on the portions of the liquid crystal panel corresponding to the backlight blocks in the second and seventh rows. On the other hand, in FIG. 3B, there is no black blank portion in the backlight blocks in the second and seventh rows, and therefore the above-described whitening phenomenon does not occur, thereby allowing display of high-definition video. Additionally, in the example shown in FIG. 3C, all the backlight blocks in the seventh row can be turned off, thereby providing an effect capable of reducing power consumption, as compared to FIG. 3A.

Note that just enlarging or reducing a video signal in the vertical direction with the scaler 104 causes a change in the aspect ratio of an image to be displayed, resulting in distortion. Therefore, preferably, the scaler 104 also performs the enlargement or reduction in the horizontal direction, at the same rate as that in the vertical direction. This might cause a partial non-display portion to occur in the horizontal direction of the image, or a blank portion to newly occur at an end in the horizontal direction. This problem can be eliminated by mainly correcting the distortion in the image central portion easily observable by a user while accepting the occurrence of the distortion on both ends in the horizontal direction so that the whole image is displayed over the entire surface in the horizontal direction.

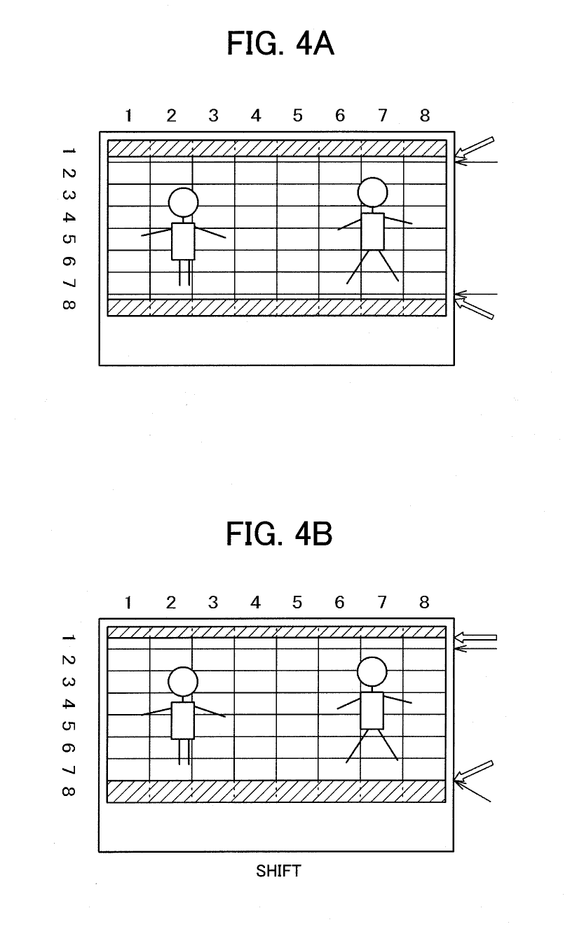

FIG. 4A shows a third example of the display screen. Also in this figure, there is shown the display in the case where the display 108 is supplied with a letterbox video signal. However, the aspect ratio of the image to be displayed is slightly different from that of FIG. 3A, and therefore, although small in width, the image is also included in the backlight blocks located in the first and eighth rows. Thus, all the backlight blocks in the first and eighth rows are lighted, thereby causing a problem that power is not effectively used.

FIG. 4B shows a shifted display screen of the third example according to the embodiment of the present invention. In this figure, the scaler 104 shifts the video signal upwardly in the vertical direction without enlarging or compressing the video signal so as to nearly align the boundary between the letterbox image and the blank portion as indicated by the bold arrow on the lower side of the image with the boundary between the backlight blocks as indicated by the thin arrow. Thus, the LED block controller 107 can turn off the backlight blocks in the eighth row, thereby allowing reduction in power consumption.

In FIG. 4A, when a vertical length of a single backlight block is represented by A; a height difference between the letterbox image boundary and the backlight block boundary (a height difference between the bold arrow and the thin arrow in the figure) on the upper side (the first-row side) is represented by B; and a height difference on the lower side (the eighth-row side) is represented by C, if the following inequation (1) is satisfied, the processing shown in FIG. 4B can be performed:

A≧B+C (1)

It should be noted that, with respect to the example shown in FIG. 4A, the video signal may reduced in the vertical direction as shown in FIG. 3C so as to turn off the backlight blocks in both the first and eighth rows.

Moreover, each of the backlight blocks is slightly irradiated with the light escaping from an adjacent backlight block. In other words, the brightness of the light from each of the backlight blocks is expressed by adding the light escaping from an adjacent backlight block. Therefore, when the backlight blocks corresponding to the blank portion are turned off, the brightness of the video corresponding to the backlight blocks adjacent thereto is also reduced. For this reason, in the examples shown in FIGS. 3B, 3C, and 4B, the LED block controller 107 may turn on, rather than entirely turning off, the backlight blocks corresponding to the blank portion, for example, at about 10 percent of the maximum brightness. Thus, it is possible to eliminate the problem of reduction in the brightness at an end of the backlight block adjacent to the backlight block corresponding to a blank portion.

Furthermore, in FIG. 4A, if a predetermined condition is satisfied, the LED block controller 107 can turn off the backlight blocks in the first and eighth rows without scaling or shifting using the scaler 104. The predetermined condition is that, in each backlight block in the first and eighth rows, the height of the portion other than the blank portion is far smaller than that of a single backlight block, and is preferably set, for example, within about 10 percent. Thus, the power consumption of backlight blocks can be reduced.

Next, the processing of a caption that is supplied together with a video signal to be broadcast and inserted into an image to be displayed by the caption insertion portion 105 will be described. As is well known, this applies to movie subtitles. As has been previously described, movies are often displayed in letterbox formats, and also often supplied with subtitles intended for display on the above-described blank portion.

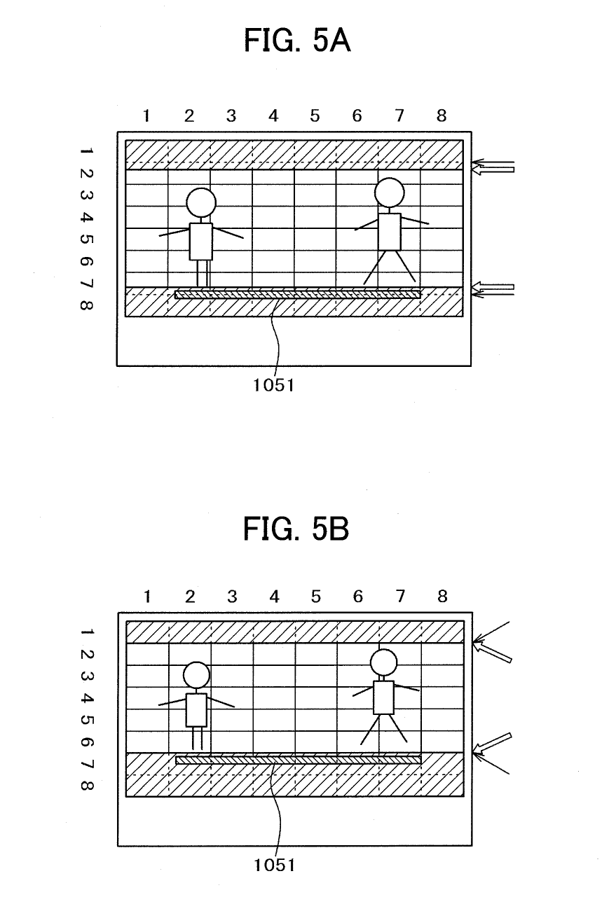

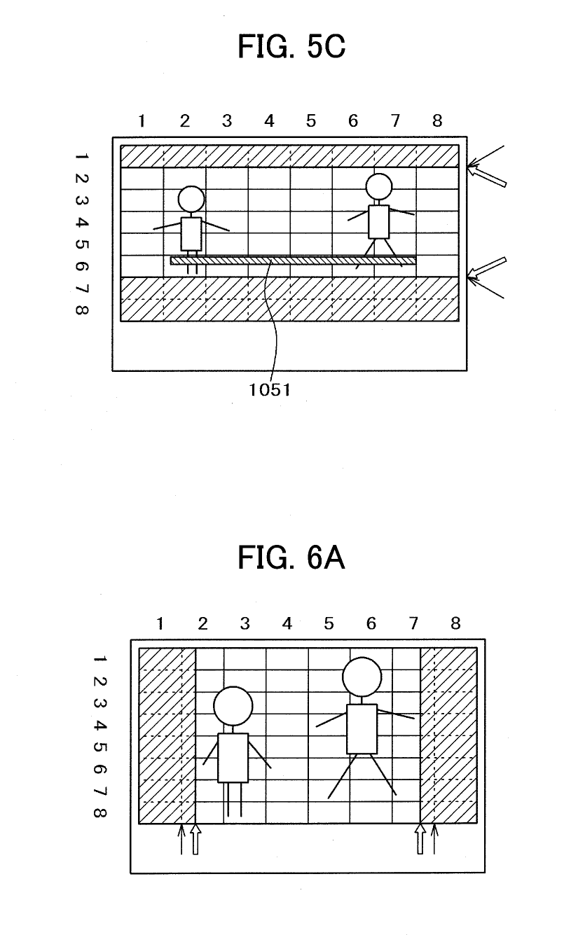

FIG. 5A shows a fourth example of the display screen. A caption 1051 is displayed, for example, on the brick-shaped hatched portion in the lower blank portion. In general, the caption is often displayed on a position, as for example shown in FIG. 5A. However, the caption display allowing for the tandem backlight has not been performed. As a result, the caption might be displayed in such a manner as to straddle the backlight blocks in the seventh and eighth rows, for example, as shown in FIG. 5A. In this case, the backlight blocks in the eighth row cannot be turned off, and therefore there is a problem that the effect of reducing power consumption is deteriorated.

FIGS. 5B and 5C each show a display screen, with the position of the caption in the fourth example shifted, according to the embodiment of the present invention.

In FIG. 5B, the video to be displayed is reduced in the same manner as FIG. 3C, however, at the time of reduction, the caption insertion portion 105 moves the caption 1051 to the backlight blocks in the seventh row so as to prevent the caption 1051 from falling over the backlight blocks in other rows. Thus, the LED block controller 107 can turn off the backlight blocks in the eighth row in addition to the backlight blocks in the first row, thereby providing an effect of reducing power consumption. It should be noted that the caption insertion portion 105 may operate, out of relation to the above-described reduction operation, to perform the insertion of the caption 1051 supplied from the caption detector 109D in such a manner as to prevent the caption 1051 from straddling the boundary between the backlight blocks. For example, the size of the caption 1051 may be changed in the vertical direction, in the horizontal direction, or in both directions.

In FIG. 5C, on the other hand, the video to be displayed is also reduced in the same manner as FIG. 3C, however, the caption insertion portion 105 inserts the caption 1051 supplied from the caption detector 109D in a superimposed manner into the video. Thus, the LED block controller 107 can turn off the backlight blocks in the seventh row, thereby providing an effect of further reducing power consumption.

As described above, the caption insertion portion 105 is disposed at the subsequent stage of the scaler 104. Thus, there is also the characteristic of preventing a change in size of the caption due to the reduction or enlargement of video with the scaler 104. Obviously, as described above, the caption insertion portion 105 may be disposed at the previous stage of the scaler 104 so that the caption is also subjected to scaling along with the image scaling.

Next, unlike the foregoing, the case, as for example where up-converted video is displayed, will be described. The up-converted video refers to video with the number of vertical lines or the like of the video having the traditional aspect ratio of 3:4 converted into an HD format for an HD broadcast. In a video display device having an aspect ratio of 9:16, contrary to the letterbox video described above, the blank portion occurs on both sides in the horizontal direction.

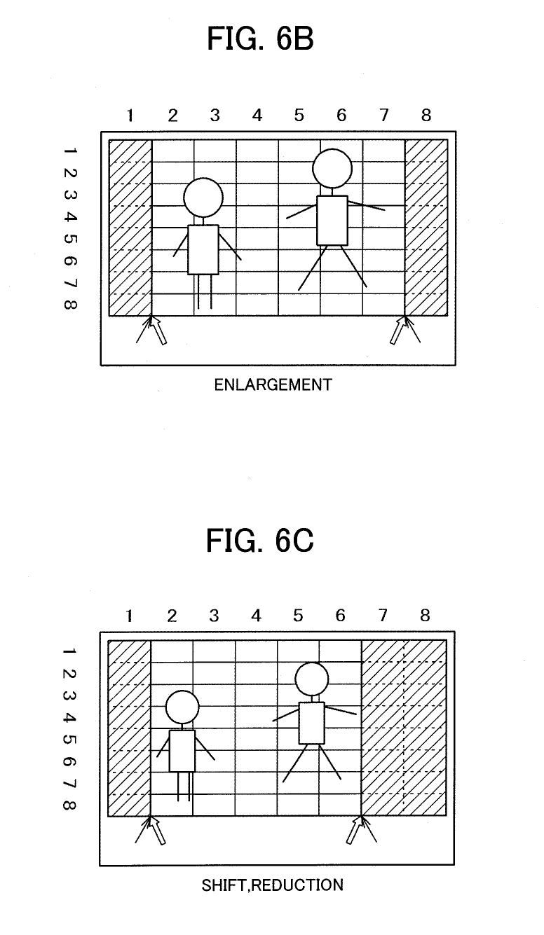

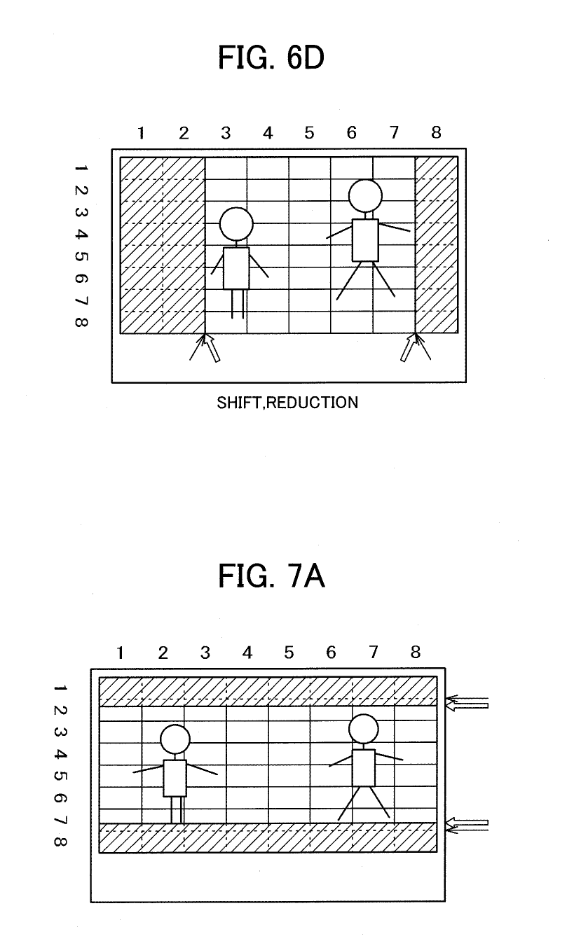

FIG. 6A shows a fifth example of the display screen, where the blank portion occurs on both sides in the horizontal direction, as described above. For example, although the backlight blocks in the second and seventh columns are turned on, those backlight blocks include portions that are not used for image display.

FIG. 6B shows an enlarged display screen of the fifth example according to the embodiment of the present invention. In FIG. 6B, relative to FIG. 6A, the video is enlarged in the horizontal direction by the scaler 104 so as to nearly align the boundary (indicated by the thin arrow in the figure) between the first and second columns and between the seventh and eighth columns with the boundary (indicated by the bold arrow in the figure) between the image and the black blank portion, thereby effectively using the whole backlight blocks in the second and seventh columns. Obviously, also in this case, the scaler 104 may perform the conversion operation for preventing distortion in the aspect ratio of the video to be displayed.

FIGS. 6C and 6D each show a shifted display screen of the fifth example according to the embodiment of the present invention. In each figure, the video display position is shifted in the horizontal direction by the scaler 104. In FIG. 6C, facing the figure, the video to be displayed is shifted to the left, and, as needed basis, reduced in the horizontal direction so that the backlight blocks in the seventh column can be turned off. In FIG. 6D, facing the figure, the video to be display is shifted to the right, and, as needed basis, reduced in the horizontal direction so that the backlight blocks in the second column can be turned off. In each case, if distortion in the aspect ratio of the video to be displayed is a problem, a further reduction in the vertical direction may be performed.

Next, an example in which video is displayed by partially using the backlight blocks in both the horizontal and vertical directions in the video display device will be described.

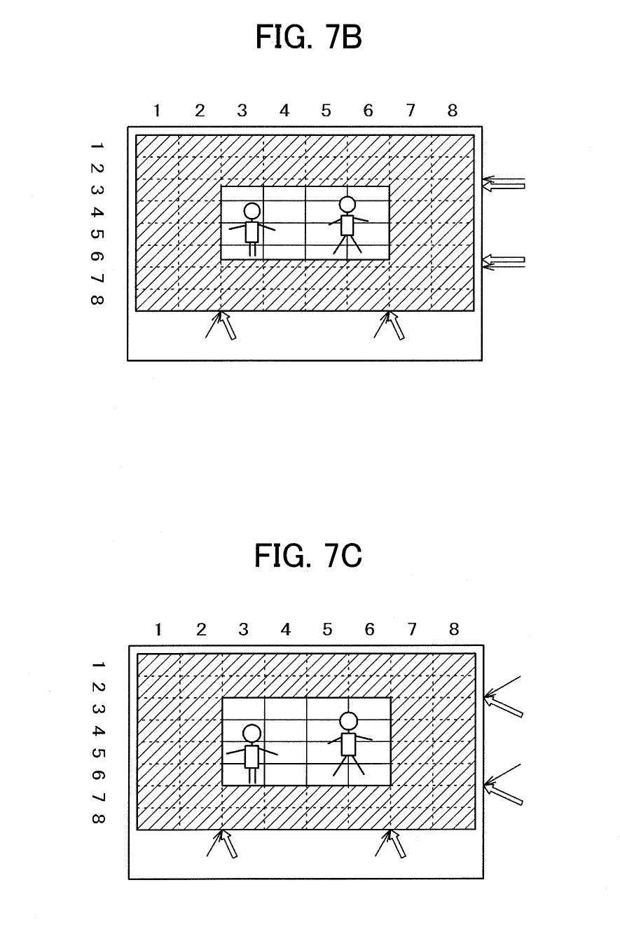

FIG. 7A shows a sixth example of the display screen, where letterbox video is displayed in the same manner as FIG. 3A. Each of the backlight blocks located, for example, in the second and seventh rows in the horizontal direction, although not entirely used for image display, cannot be turned off.

FIGS. 7B and 7C each show a reduced display screen of the sixth example according to the embodiment of the present invention. In each figure, video is reduced in both vertical and horizontal directions.

In FIG. 7B, the scaler 104 compresses the video shown in FIG. 7A at equal rate (½ in the figure) in both horizontal and vertical directions, and displays the video on a portion of the liquid crystal panel corresponding to the backlight blocks located in the third to sixth rows and in the third to sixth columns. In this case, there is a problem that as for each of the backlight blocks in the third and sixth rows, video is not displayed over the entire surface thereof. However, the LED block controller 107 turns off the backlight blocks located in the first, second, seventh, and eighth rows and in the first, second, seventh, and eighth columns, thereby allowing reduction in power consumption.

In FIG. 7C, on the other hand, the scaler 104 compresses the video shown in FIG. 7A at a different rate in the horizontal and vertical directions so as to prevent the blank portion of the video from overlapping the third and sixth rows. If the occurrence of distortion in the aspect ratio of the image to be displayed caused by the above compression is a problem, such distortion problem can be eliminated in the above-described manner. Also in FIG. 7C, the LED block controller 107 turns off the backlight blocks located in the first, second, seventh, and eighth rows and in the first, second, seventh, and eighth columns, thereby allowing reduction in power consumption. In addition, the entire surface of the lighted backlight blocks can be effectively used.

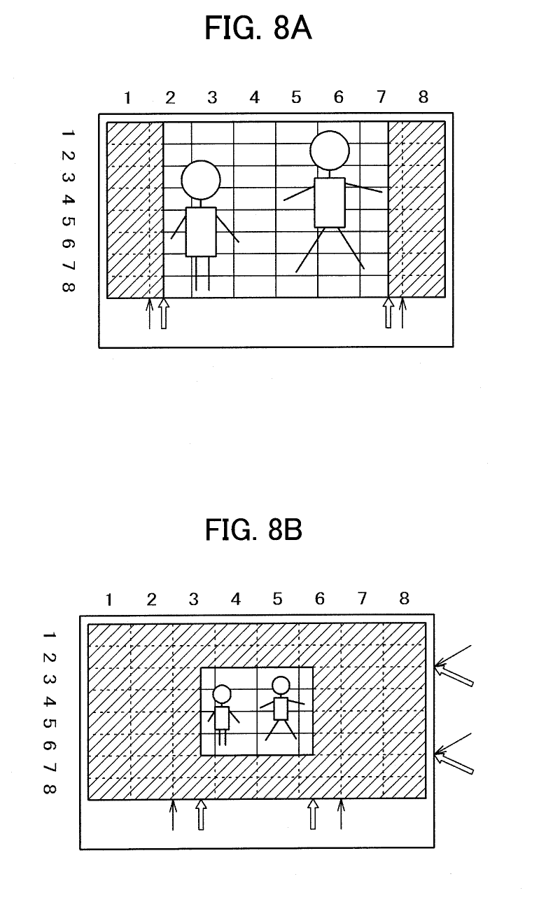

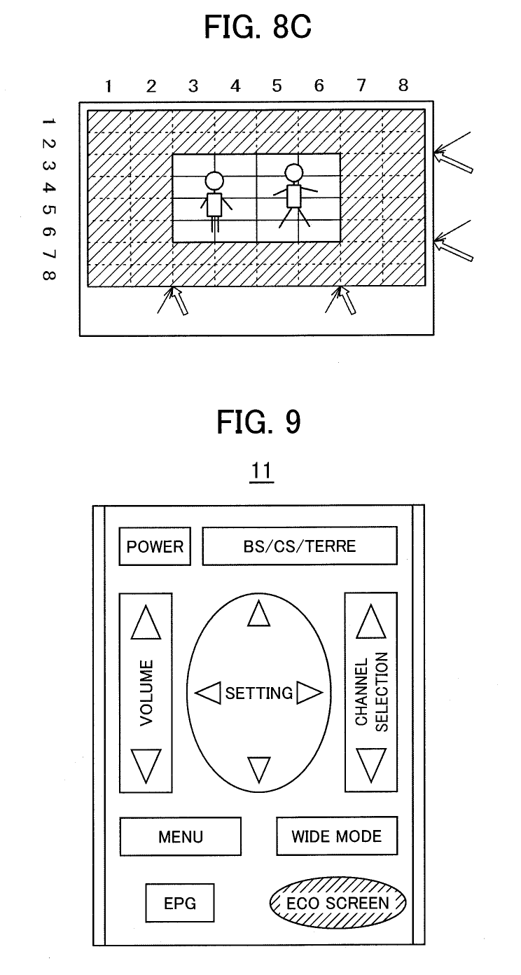

FIG. 8A shows a seventh example of the display screen, where up-converted video is displayed in the same manner as FIG. 6A. Each of the backlight blocks located, for example, in the second and seventh columns in the vertical direction, although not entirely used for image display, cannot be turned off.

FIGS. 8B and 8C each show a reduced display screen of the seventh example according to the embodiment of the present invention. In each figure, the video is reduced in both vertical and horizontal directions.

In FIG. 8B, the scaler 104 compresses the video shown in FIG. 8A at equal rate (½ in the figure) in both horizontal and vertical directions, and displays the video on the backlight blocks located in the third to sixth rows and in the third to sixth columns. In this case, there is a problem that, as for each, of the backlight blocks in the third and sixth columns, video is not displayed over the entire surface thereof. However, the LED block controller 107 turns off the backlight blocks located in the first, second, seventh, and eighth rows and in the first, second, seventh, and eighth columns, thereby allowing reduction in power consumption.

In FIG. 8C, on the other hand, the scaler 104 compresses the video shown in FIG. 8A at a different rate in the horizontal and vertical directions so as to prevent the blank portion of the video from overlapping the third and sixth columns. If the occurrence of distortion in the aspect ratio of the image to be displayed caused by the above compression is a problem, such distortion problem can be eliminated in the above-described manner. Also in FIG. 8C, the LED block controller 107 turns off the backlight blocks located in the first, second, seventh, and eighth rows and in the first, second, seventh, and eighth columns, thereby allowing reduction in power consumption. In addition, the entire surfaces of the lighted backlight blocks can be effectively used.

In the above-described embodiment shown in FIGS. 7B, 7C, 8B, and 8C, upon video reduction, the light intensity of the backlight blocks used for displaying the reduced video may be made lower than normal (at the time of full-screen display). For example, when the video corresponding to a backlight block includes a portion having the maximum brightness (for example, 8-bit expression, 255 levels of gray), the light intensity of the backlight block is set to 100 percent under normal conditions. However, in the case of displaying the reduced video, such as shown in FIG. 7B, 7C, 8B, or 8C, even when the video corresponding to a backlight block includes a portion having the maximum brightness, the light intensity of the backlight block is limited to, for example, about 90 percent. Since it is presumed that, at the time of displaying the reduced video, the user does not observe the video so carefully, there might be no problem in viewing even when the backlight intensity is decreased. In this manner, at the time of displaying the reduced video, power consumption can be further reduced.

It should be understood that, in the embodiment shown in FIGS. 7B, 7C, 8B, and 8C, the number and location of the backlight blocks used for video display are not limited to those located in the center of the display. For example, plural backlight blocks located on a left lower end thereof or a single backlight block located on a right upper end thereof may be used. Also, a function may be provided that, according to the number and location of the backlight blocks designated by a user through the remote control 11, allows the scaler 104 to perform the user's designated display. For example, a user sometimes views a large-screen display device at a short distance at bedtime. In this case, the user uses this function, thereby allowing the video display device 1 to display video in a proper size, at a proper location in both horizontal and vertical directions. In addition, the LED block controller 107 turns off the backlight blocks corresponding to the blank portion, thereby allowing reduction in power consumption.

Further, the number and location of the backlight blocks used as light sources for video display may be set by using, for example, a location sensor. Although this element is not shown in FIG. 1, for example, a location sensor applying a camera may be provided so that the video display device 1 determines, according to a user's location, the number and location of the backlight blocks used for video display.

Even if the number and location of the backlight blocks for video display are determined in any manner, as for speakers for outputting sound according to those, a predetermined number of speakers may be selected from the plural speakers. Thus, in an audio output unit, power consumption can be also reduced.

Next, the method by which a user designates a display, such as shown in FIG. 7B, 7C, 8B, or 8C, will be described.

FIG. 9 is a front view of the remote control (remote controller) 11 according to the embodiment of the present invention. As is well known, the remote control for the video display device 1 is provided with buttons for allowing a user to set the operation mode, such as a power button, a broadcast switching button (BS/CS/terrestrial digital broadcasts), a volume control button, a channel selection button, an EPG display button, a setting menu call button, and a wide mode button. In this embodiment, the setting concerning the display for reducing power consumption as described above is likely to be related to the wide mode. Therefore, the function of setting low power consumption, that is, an eco screen is incorporated into the wide mode button.

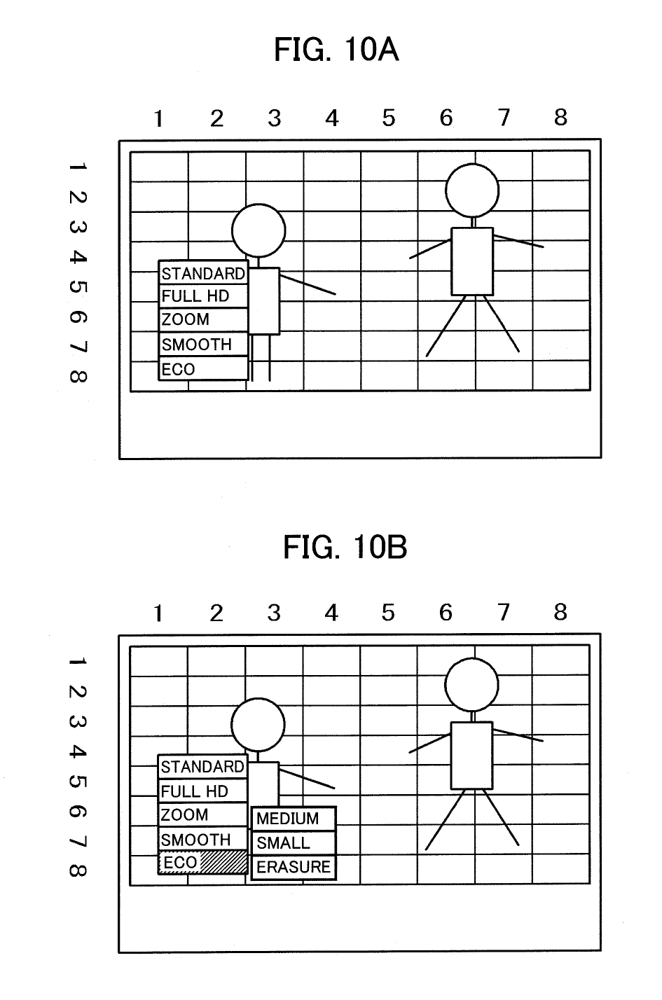

FIGS. 10A and 10B each show a display screen, with a wide mode menu displayed, according to the embodiment of the present invention.

Firstly, when the user presses the wide mode button on the remote control 11, the OSD insertion portion 106 displays an OSD image such as shown in FIG. 10A on the display of the video display device 1. In this figure, five menu items from Standard to Eco mode are shown. The user selects a desired menu item from the menu items, using the setting button on the remote control 11. In Standard mode, video having an aspect ratio of 3:4 is displayed with a blank portion on both sides in the horizontal direction as shown in FIG. 6A. In Full HD mode, for example, HD video having an aspect ratio of 9:16 is displayed in full screen as shown in FIG. 2. In Zoom mode, letterbox video is displayed in a manner enlarged so as to eliminate a blank portion in the vertical direction. In Smooth (Wide) mode, video having an aspect ratio of 3:4 is enlarged so as to prevent distortion in aspect ratio of the video central portion, thereby performing display without blank portion in the horizontal direction.

The Eco mode refers to the display on a reduced screen, such as shown in FIG. 7B, 7C, 8B, or 8C. When, on the menu screen shown in FIG. 10A, the user operates the setting button on the remote control 11 to select the menu item Eco, the image as for example shown in FIG. 10B is displayed on the video display device 1.

In FIG. 10B, the menu items “medium”, “small”, and “erasure of image” newly appear. When the user selects “medium” from these menu items, the reduced video as for example shown in FIG. 7C or 8C is displayed. When “small” is selected, further reduced video, such as video using only a single backlight block, is displayed. In this manner, the degree of reduction (reduction ratio) of the video can be selected and set by a user, and power consumption is reduced according to a display mode selected by the user.

It should be noted that all the menu items newly appearing in FIG. 10B are displayed within the backlight blocks in the third columns. This eco menu display utilizing the wide mode menu is displayed in such a manner as to be prevented from straddling the boundaries between plural backlight blocks, thereby allowing an increase in the number of backlight blocks that can be turned off by the LED block controller 107 and allowing further reduction in power consumption. Of course a similar display can be also performed on the menu screen shown in FIG. 10A. Also, not only with respect to the backlight blocks in the column direction, but also with respect to those in the row direction, displaying the menu screen in such a manner as to prevent the menu screen from straddling the boundaries between the plural backlight blocks is effective at enhancing the low power consumption effect.

The OSD insertion portion 106 is provided at the subsequent stage of the scaler 104. Thus, the video display device 1 can perform the OSD with a predetermined format, free of the influence of processing, such as the reduction, enlargement, or shift using the scaler 104.

In the above-described embodiment, description is in terms of the tandem backlight in which plural backlight blocks are two-dimensionally arranged. However, the present invention is not limited to this, but also can be applied to a so-called direct backlight in which plural light sources (LEDs) are two-dimensionally arranged on the back of a liquid crystal panel. This example will be described with reference to FIG. 12.

FIG. 12 shows a sectional view in the horizontal or vertical direction of a direct backlight to which the embodiment of the present invention is applied. In this figure, plural LEDs 1202 are arranged on an LED substrate 1201. Each of the LEDs 1202 is a top-view LED, and the LED allowing white light to exit may be used or alternatively, a combination of the three LEDs allowing red, blue, and green light to exit may be used. The light of the respective LEDs 1202 is projected onto a liquid crystal panel 1205 through a diffusion sheet 1203, a prism sheet 1204 and the like. It is to be noted that, in the same manner as the above-described embodiment, the light intensity of the LED can be controlled according to video signals.

In the above-described embodiment, the boundary between the video and the blank portion is aligned with the boundary between the backlight blocks. On the other hand, in the example of FIG. 12, about the midpoint position (half of a pitch P between the LEDs 1202) between the LEDs 1202 is set as a boundary L, and the boundary between the video and the blank portion is aligned with the boundary L, as shown in FIGS. 3 to 8. More specifically, in this example, the area up to one-half the distance between each of the LEDs and an LED (or LED groups composed of plural LEDs) adjacent thereto can serve as a backlight block. In FIG. 12, these backlight blocks are represented by reference signs BLK1 to BLK3; a boundary between the backlight blocks BLK1 and BLK2 is represented by L1; and a boundary between the backlight blocks BLK2 and BLK3 is represented by L2. It should be noted that the backlight block BLK1 is located on the end side of the display device and the backlight block BLK 3 is located on the center side thereof.

In this example, in the case, as for example where the boundary between the video and the blank portion is located in an area corresponding to the backlight block BLK1 on the liquid crystal panel 1206, the LEDs of both the backlight blocks BLK1 and BLK2 must be turned on. However, in the same manner as the above-described embodiment, if the boundary between the video and the blank portion is shifted to the position corresponding to the boundary L1 by the scaler 104 or the like, only the blank portion is displayed on the area corresponding to the backlight block BLK1 on the liquid crystal panel 1206, and therefore the LED of the backlight block BLK1 can be turned off. Thus, even in the case where the embodiment of the present invention is applied to the direct backlight, the power consumption can be favorably reduced, in the same manner as the above-described embodiment.

In FIG. 12, it is assumed that a single backlight block includes a single LED. However, the present invention is not limited thereto, and a single backlight block may, alternatively, include several or more LEDs. More specifically, the minimum unit (for example, in the case where all LEDs are divided into units each composed of five LEDs to be controlled in a set of five, the minimum unit is five) of the LED whose light intensity is controlled in the local dimming control can serve as a single backlight block.

It should be understood that the foregoing description is only illustrative of the embodiment of the present invention, and should not be taken as a limitation of the invention. Various modifications other than those discussed above may be provided with respect to the block diagram of the device, the layout of the buttons on the remote control, the video display format or the like. Therefore, different embodiments in accordance with the principles of the present invention are possible, all of which fall within the scope of the invention.

While we have a shown and described embodiment in accordance with our invention, it should be understood that the disclosed embodiment is susceptible of changes and modifications without departing from the scope of the invention. Therefore, we do not intend to be bound by the details shown and described herein but intend to cover all such changes and modifications that fall within the ambit of the appended claims.

What is claimed is:

1. A video display device having a liquid crystal panel, and a backlight with a plurality of backlight blocks horizontally and vertically arranged for projecting light onto the liquid crystal panel, capable of controlling the intensity of light for each of the backlight blocks, comprising:
a receiving portion which receives a video signal to be displayed on the liquid crystal panel;
a scaler which performs a processing to change the size and/or position in a horizontal and/or vertical direction of the video signal received by the receiving portion;
a backlight controller which controls the intensity of light for each of the backlight blocks based on the video signal; and
a display controller which controls operation of the scaler,
wherein the display controller controls the scaler to change the size and/or position in the horizontal and/or vertical direction of the video signal so as to nearly align a boundary between a video portion and a blank portion included in the video signal with a boundary between the backlight blocks, and
wherein the backlight controller performs control to reduce the intensity of light of the backlight blocks in a position corresponding to the blank portion.

2. The video display device according to claim 1, wherein the backlight is a tandem backlight in which a plurality of combinations of a light source which emits light and a light guide plate which guides the light from the light source toward the liquid crystal panel to allow the light to exit as a surface light source are two-dimensionally arranged, and wherein the backlight blocks each include at least one combination of the light source and the light guide plate.

3. The video display device according to claim 1, wherein the backlight is a direct backlight in which a plurality of light sources are two-dimensionally arranged on the back of the liquid crystal panel, and wherein the backlight blocks each include a light source group composed of at least one or a plurality of the light sources.

4. The video display device according to claim 1, wherein the scaler reduces and/or enlarges the size in the horizontal and/or vertical direction of the video signal, or shifts the position of the video signal.

5. The video display device according to claim 1, wherein the backlight controller turns off the backlight blocks in the position corresponding to the blank portion of the video signal.

6. The video display device according to claim 1, further comprising a caption insertion portion which inserts a caption in the video signal to display the caption on the liquid crystal panel, wherein the display controller controls the caption insertion portion to display the caption at a position corresponding to the backlight blocks located in a first row on the liquid crystal panel.

7. The video display device according to claim 1, wherein the scaler horizontally and vertically reduces the video signal so that the blank portion is displayed over an entire area corresponding to the backlight blocks located in the first row or in a first column on the liquid crystal panel.

8. The video display device according to claim 7, wherein ratio of the reduction of the video signal with the scaler is selectable by a user.

9. The video display device according to claim 7, further comprising a location sensor which allows the number or location of the backlight blocks used for a light source which displays the video signal to be selected according to user's location.

10. The video display device according to claim 1, further comprising an operation-input device, and an OSD insertion portion which produces an OSD according to user's operations of the operation-input device and displays at least a portion of a menu screen displayed by the OSD in one area corresponding to the backlight blocks on the liquid crystal panel.
